(19) United States
(12) Patent Application Publication
(10) Pub. No.: US 2026/0149368 A1
(43) Pub. Date: May 28, 2026

(54) DUAL-STAGE DC POWER CONVERTER

(71) Applicant: ASIAN POWER DEVICES INC., Taoyuan City (TW)

(72) Inventor: Tsung-Liang HUNG, Taoyuan City (TW)

(73) Assignee: ASIAN POWER DEVICES INC., Taoyuan City (TW)

(21) Appl. No.: 19/015,350

(22) Filed: Jan. 9, 2025

(30) Foreign Application Priority Data
Nov. 22, 2024 (TW) 113145090

(51) Int. Cl. H02M 3/00; H02M 3/158; H02M 3/335

(52) U.S. Cl. CPC H02M 3/01; H02M 3/158; H02M 3/33569

(57) ABSTRACT

A dual-stage DC power converter includes a first-stage DC converter, a second-stage DC converter, a first controller, and a second controller. The first-stage DC converter provides a first output voltage. The second-stage DC converter provides a second output voltage. The first controller receives the second output voltage, and provides a mode signal to the second controller according to the second output voltage so that the second controller provides a frequency signal to control the second-stage DC converter operating in a fixed-frequency mode or a variable-frequency mode.

### BACKGROUND

### Technical Field

The present disclosure relates to a DC power converter, and more particularly to a dual-stage DC power converter.

### Description of Related Art

The statements in this section merely provide background information related to the present disclosure and do not necessarily constitute prior art.

Resonant converters can use resonant tanks to shape the waveforms of switching voltage and/or switching current to minimize switching losses and enable high-frequency operation. Since resonant converters have advantages, such as high efficiency, simple structure that can be realized by integrating magnetic components, soft switching on primary-side switches and secondary-side switches, and suitability for applications in a wide voltage range, etc. Therefore, it can be widely used as an isolated DC-to-DC converter.

However, how to take into account efficiency, the choice of components with a low withstand voltage rating and improved hold-up time are the directions of development to which those skilled in the art attach great importance and for which they are seeking technical means.

Therefore, how to design a dual-stage DC power converter to solve the problems and technical bottlenecks in the existing technology has become a critical topic in this field.

### SUMMARY

An objective of the present disclosure is to provide a dual-stage DC power converter. The dual-stage DC power converter includes a first-stage DC converter, a second-stage DC converter, a first controller, and a second controller. The first-stage DC converter receives a DC input voltage, and converters the DC voltage into a first output voltage. The second-stage DC converter receives the first output voltage, and converts the first output voltage into a second output voltage. The first controller provides a control signal to control the first-stage DC converter. The second controller provides a frequency signal to control the second-stage DC converter. The first controller receives the second output voltage, and provides a mode signal to the second controller according to the second output voltage so that the second controller controls the second-stage DC converter operating in a fixed-frequency mode or a variable-frequency mode according to the frequency signal.

In one embodiment, the first-stage DC converter is a non-isolated DC converter, and the second-stage DC converter is an isolated DC converter.

In one embodiment, the first-stage DC converter is a boost converter, a buck converter, or a buck-boost converter.

In one embodiment, when the first controller determines that the DC input voltage is greater than an input minimum voltage and is less than an input maximum voltage according to the second output voltage, the first controller outputs the mode signal so that the second controller controls the second-stage DC converter operating in the fixed-frequency mode according to the frequency signal.

In one embodiment, in the fixed-frequency mode, the second-stage DC converter operates in a series resonance conversion.

In one embodiment, a switching frequency of the second-stage DC converter is substantially fixed, and the switching frequency is a first resonant frequency of the second-stage DC converter at the highest efficiency.

In one embodiment, the second-stage DC converter includes a resonant tank, and the resonant tank comprises a resonant inductor and a resonant capacitor connected in series. The first resonant frequency

$$fr 1 = \frac{1}{2 π \sqrt{{L}_{r} \times {C}_{r}}} ,$$

where fr1 is the first resonant frequency, Lr is the resonant inductor, Cr is the resonant capacitor.

In one embodiment, when the second-stage DC converter operates in the fixed-frequency mode, the first controller provides a pulse-width modulation signal with variable turned-on time as the control signal to control the first-stage DC converter.

In one embodiment, when the first controller determines that the DC input voltage is greater than an input threshold voltage and is less than an input maximum voltage according to the second output voltage, the first controller outputs the mode signal so that the second controller controls the second-stage DC converter operating in the fixed-frequency mode according to the frequency signal.

In one embodiment, in the fixed-frequency mode, the second-stage DC converter operates in a series resonance conversion.

In one embodiment, a switching frequency of the second-stage DC converter is substantially fixed, and the switching frequency is a first resonant frequency of the second-stage DC converter at the highest efficiency.

In one embodiment, when the second-stage DC converter operates in the fixed-frequency mode, the first controller provides a pulse-width modulation signal with variable turned-on time as the control signal to control the first-stage DC converter.

In one embodiment, when the second-stage DC converter operates in the fixed-frequency mode, the first controller provides a pulse-width modulation signal with variable turned-off time as the control signal to control the first-stage DC converter.

In one embodiment, when the first controller determines that the DC input voltage is less than an input threshold voltage and is greater than an input minimum voltage according to the second output voltage, the first controller outputs the mode signal so that the second controller controls the second-stage DC converter operating in the variable-frequency mode according to the frequency signal.

In one embodiment, in the variable-frequency mode, the second-stage DC converter operates in an inductor-inductor-capacitor conversion.

In one embodiment, when the second-stage DC converter operates in the variable-frequency mode, the first controller provides a pulse-width modulation signal with fixed turned-on time as the control signal to control the first-stage DC converter.

In one embodiment, when the second-stage DC converter operates in the variable-frequency mode, the first controller provides a pulse-width modulation signal with fixed turned-off time as the control signal to control the first-stage DC converter.

Accordingly, the dual-stage DC power converter of the present disclosure can be controlled to operate in different modes in response to different input voltages so as to achieve the advantages of taking into account efficiency, the selection of low-voltage rated components, and better hold-up time.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

The present disclosure can be more fully understood by reading the following detailed description of the embodiment, with reference made to the accompanying drawing as follows:

FIG. 1 is a block diagram of a dual-stage DC power converter according to the present disclosure.

FIG. 2 is a circuit diagram of a second-stage DC converter of the dual-stage DC power converter according to the present disclosure.

FIG. 3 is a schematic diagram of operating a first-stage DC converter and the second-stage DC converter of the dual-stage DC power converter according to a first embodiment of the present disclosure.

FIG. 4 is a schematic diagram of operating the first-stage DC converter and the second-stage DC converter of the dual-stage DC power converter according to a second embodiment of the present disclosure.

FIG. 5 is a schematic diagram of operating the first-stage DC converter and the second-stage DC converter of the dual-stage DC power converter according to a third embodiment of the present disclosure.

FIG. 6 is a schematic waveform diagram of a relationship between a voltage gain and a switching frequency of the second-stage DC converter of the dual-stage DC power converter according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

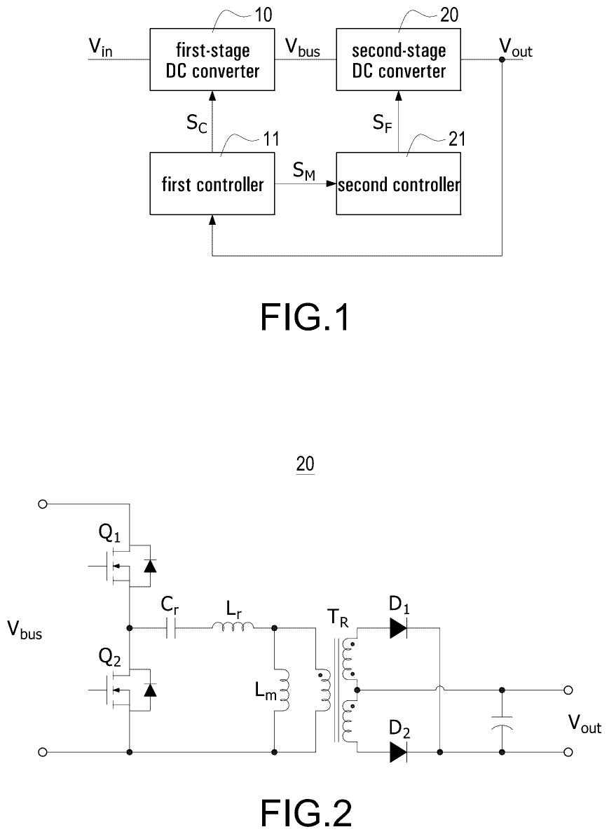

Please refer to FIG. 1, which shows a block diagram of a dual-stage DC power converter according to the present disclosure. As shown in FIG. 1, the dual-stage DC power converter includes a first-stage DC converter 10, a second-stage DC converter 20, a first controller 11, and a second controller 21. Therefore, the “dual-stage” DC power converter in the present disclosure refers to a dual-stage DC converter structure consisting of the first-stage DC converter 10 and the second-stage DC converter 20 connected in series.

The first-stage DC converter 10 receives a DC input voltage Vᵢₙ, and converts the DC input voltage Vᵢₙ into a first output voltage V_{bus}. In particular, the first-stage DC converter 10 is a non-isolated DC converter, which may be, for example, but not limited to, a boost converter, a buck converter, or a buck-boost converter. However, the present disclosure is not limited by the above-mentioned disclosures of DC converters. All non-isolated converters that can be used to achieve DC power conversion should be included in the scope of the present disclosure.

The second-stage DC converter 20 is connected to the first-stage DC converter 10, and receives a first output voltage V_{bus} and converts the first output voltage V_{bus} into a second output voltage Vₒᵤₜ. In particular, the second-stage DC converter 20 is an isolated DC converter. It can be realized from the above-mentioned disclosure that the DC input voltage Vᵢₙ is the overall input voltage of the dual-stage DC power converter, and the second output voltage Vₒᵤₜ is the overall output voltage of the dual-stage DC power converter.

The first controller 11 is coupled to the first-stage DC converter 10, and provides a control signal Sc to control the first-stage DC converter 10. The first controller 11 is a controller that controls the first-stage DC converter 10, and the second controller 21 is a controller that controls the second-stage DC converter 20. Specifically, the control signal Sc provided by the first controller 11 is used to control switch components (not shown) in the first-stage DC converter 10. The second controller 21 provides a frequency signal S_{F} to control the second-stage DC converter 20.

Therefore, the first controller 11 receives the second output voltage Vₒᵤₜ, and provides a mode signal S_{M} to the second controller 21 according to the second output voltage Vₒᵤₜ so that the second controller 21 controls the second-stage DC converter 20 operating in a fixed-frequency mode or a variable-frequency mode according to the frequency signal S_{F}.

Please refer to FIG. 2, which shows a circuit diagram of a second-stage DC converter of the dual-stage DC power converter according to the present disclosure. The second-stage DC converter 20 is an isolated DC converter, which mainly includes three parts: the first part is a switch network, the second part is a resonant tank, and the third part is a rectifier circuit. Specifically, the switch network includes a first switch Q₁ and a second switch Q₂, and the first switch Q₁ and the second switch Q₂ are connected in series at a common-connected node. The series-connected switch network receives the input voltage V_{bus}. In particular, the input voltage V_{bus} is the output voltage (i.e., the first output voltage V_{bus} shown in FIG. 1) of the first-stage DC converter 10.

The resonant tank includes a resonant inductor Lr, a resonant capacitor Cr, and a magnetizing inductor Lm of a transformer TR. In particular, transformer TR is used as electrical isolation and participates in resonance. The resonant inductor Lr is connected to the resonant capacitor Cr in series, and the series-connected resonant inductor Lr and resonant capacitor Cr are connected between the common-connected node (of the first switch Q₁ and the second switch Q₂) and the magnetizing inductor Lm, but is not limited to this.

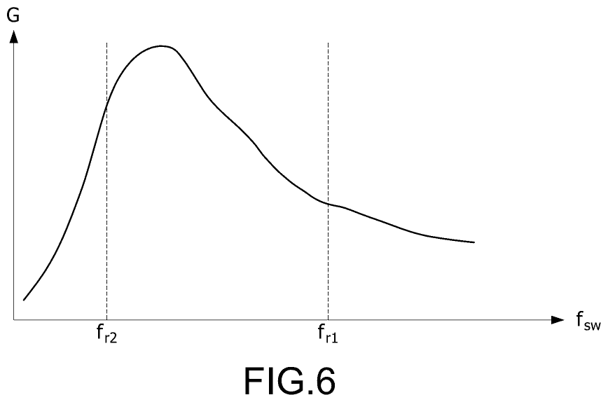

Furthermore, please refer to FIG. 6, which shows a schematic waveform diagram of a relationship between a voltage gain and a switching frequency of the second-stage DC converter of the dual-stage DC power converter according to the present disclosure. More specifically, it is a waveform diagram showing the relationship between the voltage gain and the switching frequency of the resonant tank in operation. As mentioned above, the resonant tank of the isolated DC converter of the present disclosure mainly includes a resonant inductor Lr, a resonant capacitor Cr, and a magnetizing inductor Lm. In particular, the first resonant frequency fr1 is determined by the resonant inductor Lr and the resonant capacitor Cr, that is, the magnetizing inductor Lm does not participate in the resonance operation. Therefore, the first resonant frequency (fr1):

$$fr 1 = \frac{1}{2 π \sqrt{{L}_{r} \times {C}_{r}}} ,$$

where fr1 is the first resonant frequency, Lr is the resonant inductor, and Cris the resonant capacitor. In addition, the second resonant frequency fr2 is determined by the resonant inductor Lr, the resonant capacitor Cr, and the magnetizing inductor Lm. Therefore, the second resonant frequency (fr2):

$$fr 2 = \frac{1}{2 π {\sqrt{( {L}_{r} + {L}_{m} ) \times C}}_{r}} ,$$

where fr2 is the second resonant frequency, Lr is the resonant inductor, Lm is the magnetizing inductor, and Cr is the resonant capacitor.

It can be seen from FIG. 9 that the characteristics of LLC conversion are that the right-half plane of the maximum gain point is an inductive region, and the left-half plane is a capacitive region. Moreover, when operating in the inductive region, the smaller the switching frequency (or operating frequency) fsw (that is, the lower the frequency), the greater the voltage gain G of LLC conversion. On the contrary, the larger the switching frequency fsw is (that is, the higher the frequency), the smaller the voltage gain G of LLC conversion is, and at the first resonant frequency fr1, it is unity gain (that is, the voltage gain G=1).

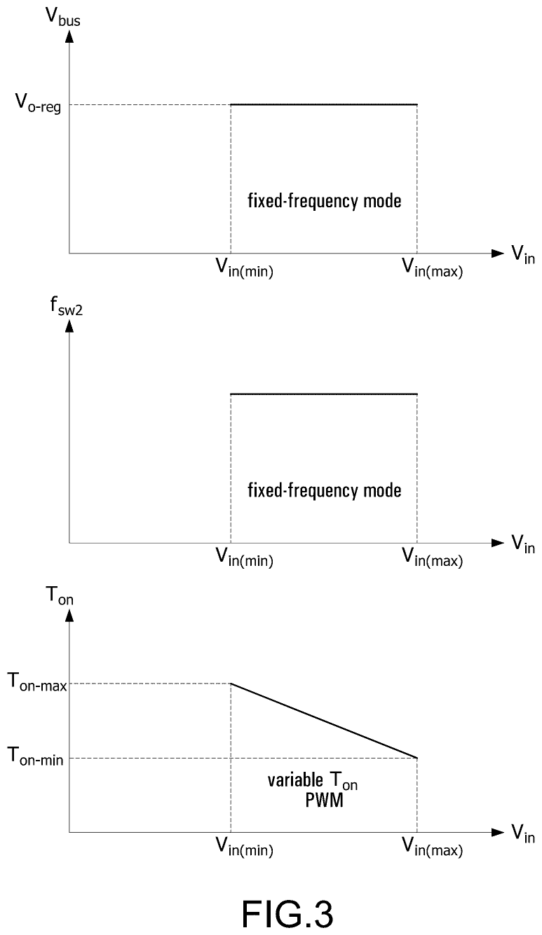

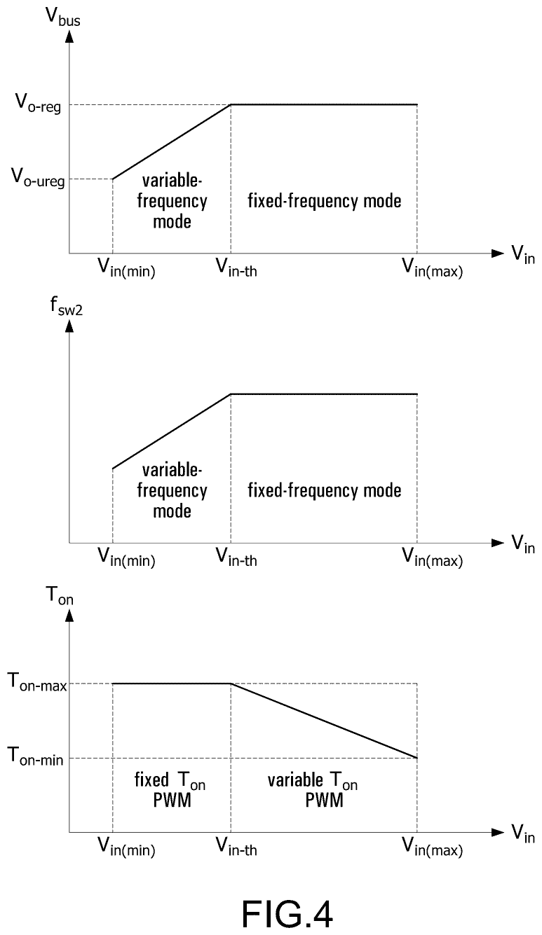

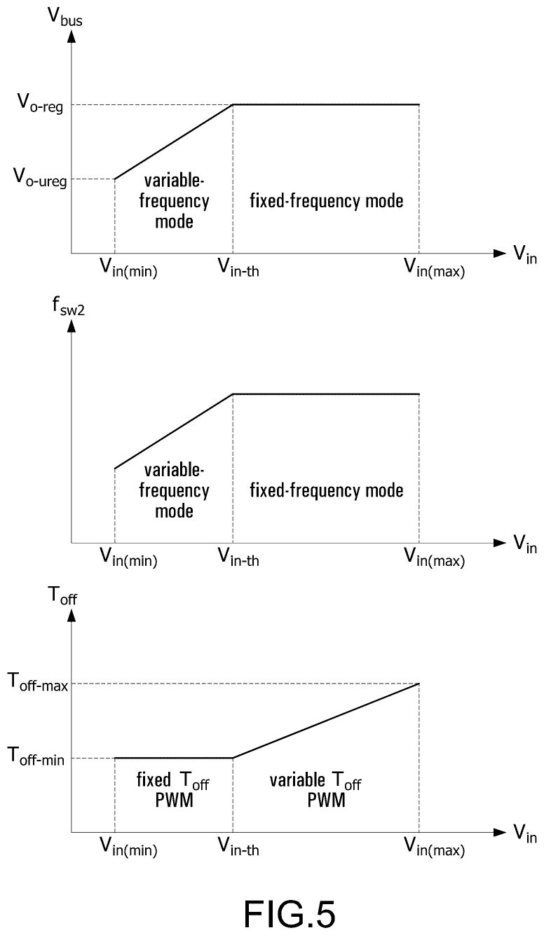

Please refer to FIG. 3, which shows a schematic diagram of operating a first-stage DC converter and the second-stage DC converter of the dual-stage DC power converter according to a first embodiment of the present disclosure. As shown in FIG. 3, the upper and middle parts show the operation of the second-stage DC converter 20, while the lower part shows the operation of the first-stage DC converter 10. Similarly, the same is true in FIG. 4 and FIG. 5, and will not be repeated here.

As shown in FIG. 3, and with reference to FIG. 1. When the first controller 11 determines that the DC input voltage Vᵢₙ is greater than the input minimum voltage Vᵢₙ₍ₘᵢₙ₎ and less than the input maximum voltage Vᵢₙ₍ₘₐₓ₎ according to the second output voltage Vₒᵤₜ, the first controller 11 outputs the mode signal S_{M} so that the second controller 21 controls the second-stage DC converter 20 to operate in the fixed-frequency mode through the frequency signal S_{F}. In the fixed-frequency mode, the second-stage DC converter 20 operates in the series resonance conversion (SRC). Specifically, the switching frequency f_{sw2} at which the second-stage DC converter 20 operates is substantially fixed, and the switching frequency is the first resonant frequency fr1 of the second-stage DC converter 20 at the highest efficiency, that is the above-mentioned first resonant frequency

$$fr 1 = \frac{1}{2 π \sqrt{{L}_{r} \times {C}_{r}}} .$$

Therefore, it is ensured that the second-stage DC converter 20 operates at the highest efficiency point, which is the first resonant frequency fr1.

Therefore, when the second-stage DC converter 20 operates in series resonance conversion in the fixed-frequency mode (i.e., f_{sw2} is a fixed value as shown in FIG. 3), the first output voltage V_{bus} of the first-stage DC converter 10 can be controlled to a fixed (or stable) output voltage value, that is, V_{bus}=V_{o-reg} as shown in FIG. 3.

Furthermore, when the second-stage DC converter 20 operates in the fixed-frequency mode, the first controller 11 provides the pulse-width modulation signal PWM with variable turned-on time Tₒₙ as the control signal Sc to control the switch components (not shown) of the first-stage DC converter 10. When the DC input voltage Vᵢₙ is larger, the turned-on time Tₒₙ is smaller; on the contrary, when the DC input voltage Vᵢₙ is smaller, the turned-on time Tₒₙ is larger. As shown in FIG. 3, when the DC input voltage Vᵢₙ changes from the input minimum voltage Vᵢₙ₍ₘᵢₙ₎ to the input maximum voltage Vᵢₙ₍ₘₐₓ₎, the turned-on time Tₒₙ is accordingly adjusted from the maximum turned-on time Tₒₙ₋ₘₐₓ to the minimum turned-on time Tₒₙ₋ₘᵢₙ.

Please refer to FIG. 4, which shows a schematic diagram of operating the first-stage DC converter and the second-stage DC converter of the dual-stage DC power converter according to a second embodiment of the present disclosure. In addition to the first embodiment shown in FIG. 3, the present disclosure can also adopt the second embodiment shown in FIG. 4, which is described as follows.

As shown in FIG. 4, when the first controller 11 determines that the DC input voltage Vᵢₙ is greater than the input threshold voltage Vᵢₙ₋ₜₕ and less than the input maximum voltage Vᵢₙ₍ₘₐₓ₎ according to the second output voltage Vₒᵤₜ, the first controller 11 outputs the mode signal S_{M} so that the second controller 21 controls the second-stage DC converter 20 to operate in the fixed-frequency mode through the frequency signal S_{F}. In the fixed-frequency mode, the second-stage DC converter 20 operates in the series resonance conversion (SRC).

Specifically, the switching frequency f_{sw2} at which the second-stage DC converter 20 operates is substantially fixed, and the switching frequency is the first resonant frequency fr1 of the second-stage DC converter 20 at the highest efficiency, that is the above-mentioned first resonant frequency

$$fr 1 = \frac{1}{2 π \sqrt{{L}_{r} \times {C}_{r}}} .$$

Therefore, it is ensured that the second-stage DC converter 20 operates at the highest efficiency point, which is the first resonant frequency fr1.

Therefore, when the second-stage DC converter 20 operates in series resonance conversion in the fixed-frequency mode (i.e., f_{sw2} is a fixed value as shown in FIG. 4), the first output voltage V_{bus} of the first-stage DC converter 10 can be controlled to a fixed (or stable) output voltage value, that is, V_{bus}=V_{o-reg} as shown in FIG. 4.

Furthermore, when the second-stage DC converter 20 operates in the fixed-frequency mode, the first controller 11 provides the pulse-width modulation signal PWM with variable turned-on time Tₒₙ as the control signal Sc to control the switch components (not shown) of the first-stage DC converter 10. When the DC input voltage Vᵢₙ is larger, the turned-on time Tₒₙ is smaller; on the contrary, when the DC input voltage Vᵢₙ is smaller, the turned-on time Tₒₙ is larger. As shown in FIG. 4, when the DC input voltage Vᵢₙ changes from the input threshold voltage Vᵢₙ₋ₜₕ to the input maximum voltage Vᵢₙ₍ₘₐₓ₎, the turned-on time Tₒₙ is accordingly adjusted from the maximum turned-on time Tₒₙ₋ₘₐₓ to the minimum turned-on time Tₒₙ₋ₘᵢₙ.

Although the SRC has higher conversion efficiency when operating in series resonance conversion, when the input voltage is low, its output voltage also decreases simultaneously. In this condition, the capacitor stores less energy, which results in a shorter hold-up time. Therefore, compared with LLC conversion, the use of SRC conversion must add more capacitors, but this also causes the problem of increased volume. On the other hand, when the input voltage is high, the output voltage under SRC conversion is high, so the input terminal of the secondary-side converter must withstand the high input voltage, and therefore more expensive high-voltage rated components need to be used. For LLC conversion, this problem does not occur since the output voltage is fixed.

In addition, when the first controller 11 determines that the DC input voltage Vᵢₙ is less than the input threshold voltage Vᵢₙ₋ₜₕ and greater than the input minimum voltage Vᵢₙ₍ₘᵢₙ₎ according to the second output voltage Vₒᵤₜ, the first controller 11 outputs the mode signal S_{M} so that the second controller 21 controls the second-stage DC converter 20 to operate in the variable-frequency mode through the frequency signal S_{F}. In the variable-frequency mode, the second-stage DC converter 20 operates in the inductor-inductor-capacitor conversion (LLC). When the DC input voltage Vᵢₙ is larger, the switching frequency f_{sw2} of the second-stage DC converter 20 is larger, and the first output voltage V_{bus} of the first-stage DC converter 10 is larger. On the contrary, when the DC input voltage Vᵢₙ is smaller, the switching frequency f_{sw2} of the second-stage DC converter 20 is smaller, and the first output voltage V_{bus} of the first-stage DC converter 10 is smaller. As shown in FIG. 4, when the DC input voltage Vᵢₙ changes from the input minimum voltage Vᵢₙ₍ₘᵢₙ₎ to the input threshold voltage Vᵢₙ₋ₜₕ, the switching frequency f_{sw2} of the second-stage DC converter 20 gradually increases, and the first output voltage V_{bus} increases from V_{o-ureg} to V_{o-reg}. On the contrary, when the DC input voltage Vᵢₙ changes from the input threshold voltage Vᵢₙ₋ₜₕ to the input minimum voltage Vᵢₙ₍ₘᵢₙ₎, the switching frequency f_{sw2} of the second-stage DC converter 20 gradually decreases, and the first output voltage V_{bus} decreases from V_{o-reg} to V_{o-ureg}.

Furthermore, when the second-stage DC converter 20 operates in the variable-frequency mode, the first controller 11 provides the pulse-width modulation signal PWM with fixed turned-on time Tₒₙ as the control signal Sc to control the switch components (not shown) of the first-stage DC converter 10. As shown in FIG. 4, when the DC input voltage Vᵢₙ is between the input minimum voltage Vᵢₙ₍ₘᵢₙ₎ and the input threshold voltage Vᵢₙ₋ₜₕ, the control signal Sc controls the switch components of the first-stage DC converter 10 with the maximum turned-on time Tₒₙ₋ₘₐₓ as the fixed turned-on time Tₒₙ. Therefore, the maximum gain of the first-stage DC converter 10 is limited to an appropriate operating range and voltage gain upper limit, and the second-stage DC converter 20 operates in the variable-frequency mode of LLC to provide additional voltage gain. Therefore, the total voltage gain of the system is the product of these two stages to keep the output voltage stable. Although the conversion efficiency is not at its highest point at this time, since the time is short, only tens of milliseconds, it will not cause the temperature to be too high.

Please refer to FIG. 5, which shows a schematic diagram of operating the first-stage DC converter and the second-stage DC converter of the dual-stage DC power converter according to a third embodiment of the present disclosure. In addition to the first embodiment shown in FIG. 3 and the second embodiment shown in FIG. 4, the present disclosure can also adopt the third embodiment shown in FIG. 5, which is described as follows.

As shown in FIG. 5, when the first controller 11 determines that the DC input voltage Vᵢₙ is greater than the input threshold voltage Vᵢₙ₋ₜₕ and less than the input maximum voltage Vᵢₙ₍ₘₐₓ₎ according to the second output voltage Vₒᵤₜ, the first controller 11 outputs the mode signal S_{M} so that the second controller 21 controls the second-stage DC converter 20 to operate in the fixed-frequency mode through the frequency signal S_{F}. In the fixed-frequency mode, the second-stage DC converter 20 operates in the series resonance conversion (SRC). Specifically, the switching frequency f_{sw2} at which the second-stage DC converter 20 operates is substantially fixed, and the switching frequency is the first resonant frequency fr1 of the second-stage DC converter 20 at the highest efficiency, that is the above-mentioned first resonant frequency

$$fr 1 = \frac{1}{2 π \sqrt{{L}_{r} \times {C}_{r}}} .$$

Therefore, it is ensured that the second-stage DC converter 20 operates at the highest efficiency point, which is the first resonant frequency fr1.

Therefore, when the second-stage DC converter 20 operates in series resonance conversion in the fixed-frequency mode (i.e., f_{sw2} is a fixed value as shown in FIG. 5), the first output voltage V_{bus} of the first-stage DC converter 10 can be controlled to a fixed (or stable) output voltage value, that is, V_{bus}=V_{o-reg} as shown in FIG. 5.

Furthermore, when the second-stage DC converter 20 operates in the fixed-frequency mode, the first controller 11 provides the pulse-width modulation signal PWM with variable turned-off time T_{off} as the control signal Sc to control the switch components (not shown) of the first-stage DC converter 10. When the DC input voltage Vᵢₙ is larger, the turned-off time T_{off} is larger; on the contrary, when the DC input voltage Vᵢₙ is smaller, the turned-off time T_{off} is smaller As shown in FIG. 5, when the DC input voltage Vᵢₙ changes from the input threshold voltage Vᵢₙ₋ₜₕ to the input maximum voltage Vᵢₙ₍ₘₐₓ₎, the turned-off time T_{off} is accordingly adjusted from the minimum turned-off time T_{off-min} to the maximum turned-off time T_{off-max}.

In addition, when the first controller 11 determines that the DC input voltage Vᵢₙ is less than the input threshold voltage Vᵢₙ₋ₜₕ and greater than the input minimum voltage Vᵢₙ₍ₘᵢₙ₎ according to the second output voltage Vₒᵤₜ, the first controller 11 outputs the mode signal S_{M} so that the second controller 21 controls the second-stage DC converter 20 to operate in the variable-frequency mode through the frequency signal S_{F}. In the variable-frequency mode, the second-stage DC converter 20 operates in the inductor-inductor-capacitor conversion (LLC). When the DC input voltage Vᵢₙ is larger, the switching frequency f_{sw2} of the second-stage DC converter 20 is larger, and the first output voltage V_{bus} of the first-stage DC converter 10 is larger. On the contrary, when the DC input voltage Vᵢₙ is smaller, the switching frequency f_{sw2} of the second-stage DC converter 20 is smaller, and the first output voltage V_{bus} of the first-stage DC converter 10 is smaller. As shown in FIG. 5, when the DC input voltage Vᵢₙ changes from the input minimum voltage Vᵢₙ₍ₘᵢₙ₎ to the input threshold voltage Vᵢₙ₋ₜₕ, the switching frequency f_{sw2} of the second-stage DC converter 20 gradually increases, and the first output voltage V_{bus} increases from V_{o-ureg} to V_{o-reg}. On the contrary, when the DC input voltage Vᵢₙ changes from the input threshold voltage Vᵢₙ₋ₜₕ to the input minimum voltage Vᵢₙ₍ₘᵢₙ₎, the switching frequency f_{sw2} of the second-stage DC converter 20 gradually decreases, and the first output voltage V_{bus} decreases from V_{o-reg} to V_{o-ureg}.

Furthermore, when the second-stage DC converter 20 operates in the variable-frequency mode, the first controller 11 provides the pulse-width modulation signal PWM with fixed turned-off time T_{off} as the control signal Sc to control the switch components (not shown) of the first-stage DC converter 10. As shown in FIG. 5, when the DC input voltage Vᵢₙ is between the input minimum voltage Vᵢₙ₍ₘᵢₙ₎ and the input threshold voltage Vᵢₙ₋ₜₕ, the control signal Sc controls the switch components of the first-stage DC converter 10 with the minimum turned-off time T_{off-min} as the fixed turned-off time T_{off}.

Accordingly, the dual-stage DC power converter of the present disclosure can be controlled to operate in different modes in response to different input voltages so as to achieve the advantages of taking into account efficiency, the selection of low-voltage rated components, and better hold-up time.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A dual-stage DC power converter, comprising:
a first-stage DC converter configured to receive a DC input voltage, and converter the DC voltage into a first output voltage,
a second-stage DC converter configured to receive the first output voltage, and convert the first output voltage into a second output voltage,
a first controller configured to provide a control signal to control the first-stage DC converter, and
a second controller configured to provide a frequency signal to control the second-stage DC converter,
wherein the first controller is configured to receive the second output voltage, and provide a mode signal to the second controller according to the second output voltage so that the second controller is configured to control the second-stage DC converter operating in a fixed-frequency mode or a variable-frequency mode according to the frequency signal.

2. The dual-stage DC power converter as claimed in claim 1, wherein the first-stage DC converter is a non-isolated DC converter, and the second-stage DC converter is an isolated DC converter.

3. The dual-stage DC power converter as claimed in claim 2, wherein the first-stage DC converter is a boost converter, a buck converter, or a buck-boost converter.

4. The dual-stage DC power converter as claimed in claim 1, wherein when the first controller is configured to determine that the DC input voltage is greater than an input minimum voltage and is less than an input maximum voltage according to the second output voltage, the first controller is configured to output the mode signal so that the second controller is configured to control the second-stage DC converter operating in the fixed-frequency mode according to the frequency signal.

5. The dual-stage DC power converter as claimed in claim 4, wherein in the fixed-frequency mode, the second-stage DC converter is configured to operate in a series resonance conversion.

6. The dual-stage DC power converter as claimed in claim 4, wherein a switching frequency of the second-stage DC converter is substantially fixed, and the switching frequency is a first resonant frequency of the second-stage DC converter at the highest efficiency.

7. The dual-stage DC power converter as claimed in claim 6, wherein the second-stage DC converter comprises a resonant tank, and the resonant tank comprises a resonant inductor and a resonant capacitor connected in series,
wherein the first resonant frequency
$$fr 1 = \frac{1}{2 π \sqrt{{L}_{r} \times {C}_{r}}} ,$$
where fr1 is the first resonant frequency, Lr is the resonant inductor, Cr is the resonant capacitor.

8. The dual-stage DC power converter as claimed in claim 4, wherein when the second-stage DC converter operates in the fixed-frequency mode, the first controller is configured to provide a pulse-width modulation signal with variable turned-on time as the control signal to control the first-stage DC converter.

9. The dual-stage DC power converter as claimed in claim 1, wherein when the first controller is configured to determine that the DC input voltage is greater than an input threshold voltage and is less than an input maximum voltage according to the second output voltage, the first controller is configured to output the mode signal so that the second controller is configured to control the second-stage DC converter operating in the fixed-frequency mode according to the frequency signal.

10. The dual-stage DC power converter as claimed in claim 9, wherein in the fixed-frequency mode, the second-stage DC converter is configured to operate in a series resonance conversion.

11. The dual-stage DC power converter as claimed in claim 9, wherein a switching frequency of the second-stage DC converter is substantially fixed, and the switching frequency is a first resonant frequency of the second-stage DC converter at the highest efficiency.

12. The dual-stage DC power converter as claimed in claim 9, wherein when the second-stage DC converter operates in the fixed-frequency mode, the first controller is configured to provide a pulse-width modulation signal with variable turned-on time as the control signal to control the first-stage DC converter.

13. The dual-stage DC power converter as claimed in claim 9, wherein when the second-stage DC converter operates in the fixed-frequency mode, the first controller is configured to provide a pulse-width modulation signal with variable turned-off time as the control signal to control the first-stage DC converter.

14. The dual-stage DC power converter as claimed in claim 1, wherein when the first controller is configured to determine that the DC input voltage is less than an input threshold voltage and is greater than an input minimum voltage according to the second output voltage, the first controller is configured to output the mode signal so that the second controller is configured to control the second-stage DC converter operating in the variable-frequency mode according to the frequency signal.

15. The dual-stage DC power converter as claimed in claim 14, wherein in the variable-frequency mode, the second-stage DC converter is configured to operate in an inductor-inductor-capacitor conversion.

16. The dual-stage DC power converter as claimed in claim 14, wherein when the second-stage DC converter operates in the variable-frequency mode, the first controller is configured to provide a pulse-width modulation signal with fixed turned-on time as the control signal to control the first-stage DC converter.

17. The dual-stage DC power converter as claimed in claim 14, wherein when the second-stage DC converter operates in the variable-frequency mode, the first controller is configured to provide a pulse-width modulation signal with fixed turned-off time as the control signal to control the first-stage DC converter.
